(19) United States
(12) Patent Application Publication
(10) Pub. No.: US 2025/0122089 A1
(43) Pub. Date: Apr. 17, 2025

(54) METHOD OF EXTRACTING AND SEPARATING GALLIUM BY EMULSION LIQUID MEMBRANE

(71) Applicant: BGRIMM Technology Group, Beijing (CN)

(72) Inventors: Hao MA, Montreal (CA); Fan GUO, Beijing (CN); Chaozhen ZHENG, Beijing (CN); Qifan ZHOU, Beijing (CN); Sanping LIU, Beijing (CN); Haibei WANG, Beijing (CN); Shengdong WANG, Beijing (CN); Da LI, Beijing (CN)

(73) Assignee: BGRIMM Technology Group, Beijing (CN)

(21) Appl. No.: 18/677,950

(22) Filed: May 30, 2024

(30) Foreign Application Priority Data
Oct. 11, 2023 (CN) 202311308779.9

(51) Int. Cl. C01G 15/00; B01D 61/40

(52) U.S. Cl. CPC C01G 15/003; B01D 61/40; B01D 2311/12; B01D 2311/246

(57) ABSTRACT

Provided is method of extracting and separating gallium by emulsion liquid membrane. The method of extracting and separating gallium by emulsion liquid membrane includes preparation of the emulsion liquid membrane, extraction and deextraction. By establishing a proper emulsion liquid membrane system, gallium is selectively extracted from the gallium leaching solution. In the scheme of the present disclosure, chosen factors are optimized through fractional fractorial design and central composite design so as to obtain an optimal processing scheme. The influences of gallium solution/emulsion volume ratio, extractant concentration, H₂SO₄ concentration, emulsion stirring duration and emulsion stirring speed on the gallium extraction rate are studied, and efficient enrichment of gallium is achieved. Besides, reproducibility of the emulsion liquid membrane is also studied, and after demulsification, the separated oil is used again for experiments, without obvious difference from newly prepared emulsion liquid membrane.

### CROSS-REFERENCE TO RELATED APPLICATION

The present disclosure claims the priority to the Chinese patent application with the filing No. 2023113087799 filed with the Chinese Patent Office on Oct. 11, 2023, and entitled “METHOD OF EXTRACTING AND SEPARATING GALLIUM BY EMULSION LIQUID MEMBRANE”, the contents of which are incorporated herein by reference in entirety.

### TECHNICAL FIELD

The present disclosure relates to the technical field of hydrometallurgical separation and extraction of gallium, and particularly to a method of extracting and separating gallium by emulsion liquid membrane.

### BACKGROUND ART

Gallium is a byproduct during aluminum and zinc smelting, and is widely used in semiconductor field, solar cells, hydrogen energy sources and medical field due to its low melting point, high boiling point, good superconductivity, good ductility and excellent heat shrinkage and cold expansion properties.

Extraction of gallium from zinc smelting byproducts includes a reduction roasting and magnetic separation method, a complex adsorption method and a solvent extraction method. With regard to the solvent extraction method, the key to gallium recovery is to choose proper gallium extractant and extraction method. The existing solvent extraction method has reaction equilibrium constant limit and low extraction rate, while in emulsion liquid membrane technique, metal ions and extractant undergo cation and anion exchange to generate metal ion complexes, and the metal ion complexes are self-transported to sulfuric acid phase where deextractant is located for deextraction reaction, thus extraction and deextraction may be carried out simultaneously, and the metal ions are left in the sulfuric acid phase for concentration enrichment. Moreover, extractant regeneration may accelerate the reaction equilibrium constant, thereby further shortening extraction time.

### SUMMARY

The present disclosure aims at providing a method of extracting and separating gallium by emulsion liquid membrane, so as to solve the above problems.

In order to achieve the above objective, the present disclosure adopts the following technical solutions.

A method of extracting and separating gallium by emulsion liquid membrane, including:
preparation of the emulsion liquid membrane: dispersing an extraction reagent into small droplets, suspending the droplets in liquid matrix to obtain primary emulsion, and to the primary emulsion adding a surfactant and stirring the resultant, so as to obtain the emulsion liquid membrane;
extraction: mixing a gallium leaching solution with the emulsion liquid membrane, so as to obtain gallium extractant complexes; and
deextraction: separating the gallium extractant complexes to obtain oil phase and water phase, and demulsifying the oil phase and releasing concentrated gallium ion water phase solution.

The emulsion liquid membrane is a technique that combines organic extraction and deextraction. A schematic diagram of the method of extracting and separating gallium by emulsion liquid membrane of the present disclosure is as shown in FIG. 1. A raw material liquid is configured as emulsion liquid membrane extractant under high-frequency ultrasound, and then the emulsion liquid membrane extractant is mixed with a gallium-containing solution (as shown in FIG. 1(a)). Under fixed rate stirring, gallium ions and the extractant undergo cation and anion exchange to generate metal ion complexes (as shown in FIGS. 1(b), (c)), and the metal ion complexes are self-transported to sulfuric acid phase where deextractant is located for deextraction reaction (as shown in FIG. 1(d)). This process eliminates the reaction equilibrium constant limit of traditional organic extraction and improves extraction rate.

Preferably, the extraction reagent includes 0,0-dihydroxyphosphorus hydroxamic acid with molecular formula of (RO)₂P(O)NHOH and a diluent, where R is hydrocarbyl with a carbon chain length of 4˜20 carbons, and the hydrocarbyl is saturated alkyl, or alkylene containing an unsaturated bond or aryl containing a benzene ring. In the above, 0,0-dihydroxyphosphorus hydroxamic acid may be, for example, extractant G8351. G8351 is 0,0-dihydroxyphosphorus hydroxamic acid produced by the applicant. G8351 is oily and very viscous. The diluent is also oily. G8315 can be completely dissolved in the diluent. The purpose of dilution is to reduce viscosity of G8315. Oil obtained by mixing 0,0-dihydroxyphosphorus hydroxamic acid and the diluent is of a transparent color.

Preferably, the diluent includes any one of sulfonated kerosene, gasoline and diesel oil.

Preferably, mass percentage of the 0,0-dihydroxyphosphorus hydroxamic acid is 20%.

Preferably, mass percentage concentration of the O,O-dihydroxyphosphorus hydroxamic acid in the diluent is 3.5-8.0%. For example, it may be 3.5%, 4.0%, 4.5%, 5.0%, 5.5%, 6.0%, 6.5%, 7.0%, 7.5% or 8.0%, or any value of 3.5-8.0%.

Preferably, a volume ratio of the gallium leaching solution to the emulsion liquid membrane is (3-7):1. For example, it may be 3:1, or 3.5:1, or 4:1, or 4.5:1, or 5:1, or 5.5:1, or 6:1, or 6.5:1, or 7:1, or any value of (3-7):1.

Preferably, the liquid matrix is H₂SO₄, and concentration of the H₂SO₄ is 2-5 mol/L. For example, it may be 2 mol/L, 2.5 mol/L, 3 mol/L, 3.5 mol/L, 4 mol/L, 4.5 mol/L or 5 mol/L, or any value of 2-5 mol/L.

Preferably, the surfactant is any one or two selected from sorbitan monooleate and sorbitan monostearate. Sorbitan monooleate is Span-80. Sorbitan monostearate is Span-60.

Preferably, the extraction reagent is dispersed into small droplets using an ultrasonic generator; and after the surfactant is added to the primary emulsion, a mechanical stirrer is used to stir so as to obtain the emulsion liquid membrane.

Preferably, a stirring duration of the mechanical stirrer is 10-30 minutes, for example, it may be 10 minutes, 15 minutes, 20 minutes, 25 minutes or 30 minutes, or any value of 10-30 minutes. A stirring speed is 300-500 rpm, for example, may be 300 rpm, 350 rpm, 400 rpm, 450 rpm or 500 rpm, or any value of 300-500 rpm.

Preferably, an ultrasonic duration is 0.5-5 min, for example, it may be 0.5 min, 1 min, 1.5 min, 2 min, 2.5 min, 3 min, 3.5 min, 4 min, 4.5 min or 5 min, or any one of 0.5-5 min.

Compared with the prior art, beneficial effects of the present disclosure include the following.

The method of extracting and separating gallium by emulsion liquid membrane provided in the present disclosure includes preparation of the emulsion liquid membrane, extraction and deextraction. By establishing a proper emulsion liquid membrane system, gallium is selectively extracted from the gallium leaching solution. In the scheme of the present disclosure, chosen factors are optimized through fractional fractorial design and central composite design so as to obtain an optimal processing scheme. The influences of gallium solution/emulsion volume ratio, extractant concentration, H₂SO₄ concentration, emulsion stirring duration and emulsion stirring speed on the gallium extraction rate are studied, and efficient enrichment of gallium is achieved. Besides, reproducibility of the emulsion liquid membrane is also studied, and after demulsification, the separated oil is used again for experiments, without obvious difference from newly prepared emulsion liquid membrane.

### BRIEF DESCRIPTION OF DRAWINGS

In order to more clearly illustrate the technical solutions of the examples of the present disclosure, drawings that need to be used in the examples will be briefly introduced below. It should be understood that the following drawings show merely some examples of the present disclosure, and therefore should not be considered as limitation to the scope of the present disclosure.

FIG. 1 is a schematic diagram of a method of extracting and separating gallium by emulsion liquid membrane in the present disclosure.

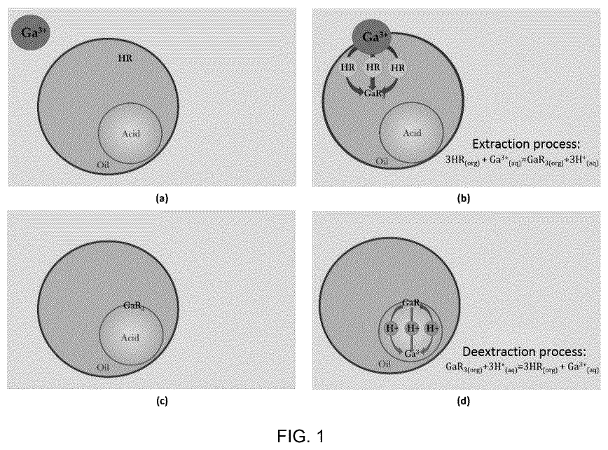

### DETAILED DESCRIPTION OF EMBODIMENTS

For example, regarding the terms used herein:
“prepared from . . . ” is synonymous with “comprising”. The terms “comprising”, “including”, “having”, “containing” or any other derivatives thereof, as used herein, are intended to cover non-exclusive inclusion. For example, a composition, step, method, article or apparatus comprising the listed elements is not necessarily only limited to those elements, but may include other elements not explicitly listed or elements inherent to such composition, step, method, article or apparatus.

The conjunction “consisting of . . . ” excludes any unspecified element, step or component. If used in a claim, this phrase will make the claim closed, so that the claim does not contain materials other than those described, but conventional impurities related thereto are excluded. When the phrase “consisting of . . . ” appears in the clause of the claim body rather than immediately after the subject, it only defines the elements described in the clause; and other elements are not excluded from the claim as a whole.

When an amount, concentration, or other values or parameters are expressed in a range, a preferred range, or a series of range defined by an upper preferred limit value and a lower preferred limit value, this should be understood as specifically disclosing all ranges formed by any pair of an upper limit value in any range or a preferred value and a lower limit value of any range or a preferred value, regardless of whether this range is separately disclosed. For example, when a range “1˜5” is disclosed, the range described should be interpreted to include ranges “1˜4”, “1˜3”, “1˜2”, “1˜2 and 4˜5”, “1˜3 and 5”, etc. When a numerical range is described herein, unless otherwise specified, this range is intended to include its end values and all integers and fractions within this range.

In these examples, unless otherwise indicated, the stated parts and percentages are by mass.

The term “part by mass” refers to a basic measurement unit that represents the mass ratio relationship of multiple components, and 1 part can represent any unit mass, such as 1 g, 2.689 g, and the like. If part by mass of A component is a parts, and part by mass of B component is b parts, this means that a ratio of mass of the A component to mass of the B component is a:b. Alternatively, it means that the mass of the component A is aK, and the mass of the component B is bK (K is any number, and represents a multiplication factor). Unmistakably, unlike mass fractions, a sum of parts by mass of all components is not limited to 100 parts.

“And/or” is used to indicate that one or both of illustrated situations may occur, for example, A and/or B include (A and B) and (A or B).

Implementation solutions of the present disclosure will be described in detail below with reference to specific examples, but those skilled in the art would understand that the following examples are merely used to illustrate the present disclosure and should not be regarded as limiting the scope of the present disclosure. If no specific conditions are specified in the examples, they are carried out under normal conditions or conditions recommended by manufacturers. If manufacturers of reagents or apparatus used are not specified, they are conventional products commercially available.

G8315 used in the following examples is 0,0-dihydroxyphosphorus hydroxamic acid produced by the applicant, and mass percentage thereof is 20%.

### Example 1

Gallium leaching solution was leaching supernatant by first-stage pressurization for zinc sulfide, wherein concentration of gallium was 0.024 g/L, and analysis of components thereof is shown in Table 1. Although concentration of gallium leaching solution from factory is 24 ppm, in order to promote adaptability of emulsion liquid membrane, the solution was specially evaporated and concentrated to concentration up to 50 ppm for testing, so as to render wider popularization. In the above, pH of original gallium leaching solution was 1.70, and pH of the concentrated solution was 1.39.

TABLE 1
Analysis of Components of Zinc Sulfide Pressurized Supernatant

| Component | Zn | Fe | Si | H⁺ | Ga | Ge |
|---|---|---|---|---|---|---|
| Content/g/L | 146.94 | 16.33 | 0.038 | 0.64 | 0.024 | 0.016 |

Example 1 provides a method of extracting and separating gallium by emulsion liquid membrane, including:
(1) ultrasonically dispersing 8.0 wt % G8315 oil drops dissolved in sulfonated kerosene for 1 min into smaller droplets using an ultrasonic generator, suspending the droplets in liquid matrix of 5 mol/L sulfuric acid solution according to an oil to acid ratio of 5:1 to obtain primary emulsion, and further adding sorbitan monooleate with concentration of 2 wt %, and stirring at 480 rpm for 30 minutes using a mechanical stirrer, so as to obtain emulsion liquid membrane;
(2) mixing gallium leaching solution with the emulsion liquid membrane at a volume ratio of 3.2, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused.

Results show that the high extractant concentration of 8.0 wt % and the low gallium solution/emulsion volume ratio of 3.2 result in a high gallium extraction yield (extraction efficiency may reach 99.7%, exceeding 99%), and gallium ion enrichment concentration may reach 19.2 times.

### Example 2

The gallium leaching solution used in Example 2 was the same as that used in Example 1.

Example 2 provides a method of extracting and separating gallium by emulsion liquid membrane, including:
(1) ultrasonically dispersing 5.0 wt % G8315 oil drops dissolved in sulfonated kerosene for 1 min into smaller droplets using an ultrasonic generator, suspending the droplets in liquid matrix of 3 mol/L sulfuric acid solution according to an oil to acid ratio of 5:1 to obtain primary emulsion, and further adding sorbitan monooleate with concentration of 2 wt %, and stirring at 400 rpm for 20 minutes using a mechanical stirrer, so as to obtain emulsion liquid membrane;
(2) mixing gallium leaching solution with the emulsion liquid membrane at a volume ratio of 5.0, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused.

Results show that the extractant concentration of 5.0 wt % and the gallium solution/emulsion volume ratio of 5.0 may reach extraction efficiency of 90.3%, exceeding 90%), and gallium ion enrichment concentration may reach 27 times.

### Example 3

Gallium leaching solution was leaching supernatant by first-stage pressurization for zinc sulfide shown in Table 1, containing 0.024 g/L gallium. The solution was evaporated and concentrated to concentration up to 100 ppm for testing.

Example 3 provides a method of extracting and separating gallium by emulsion liquid membrane, including:
(1) ultrasonically dispersing 6.5 wt % G8315 oil drops dissolved in sulfonated kerosene for 1 min into smaller droplets using an ultrasonic generator, suspending the droplets in 4 mol/L sulfuric acid solution according to an oil to acid ratio of 5:1 to obtain primary emulsion, and further adding sorbitan monooleate with concentration of 2 wt % to the primary emulsion, and stirring at 300 rpm for 25 minutes using a mechanical stirrer, so as to obtain emulsion liquid membrane, wherein pH of original gallium solution was 1.70, and pH of the concentrated gallium solution was 1.09;
(2) mixing gallium leaching solution with the emulsion liquid membrane at a volume ratio of 3.5:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that Example 3 achieves extraction efficiency value about 96.6%, and gallium ion enrichment concentration may reach 20.3 times.

### Example 4

Gallium leaching solution was leaching supernatant by first-stage pressurization for zinc sulfide shown in Table 1, containing 0.024 g/L gallium. The solution was evaporated and concentrated to concentration up to 100 ppm for testing.

Example 4 provides a method of extracting and separating gallium by emulsion liquid membrane, including:
(1) ultrasonically dispersing 5 wt % G8315 oil drops dissolved in sulfonated kerosene for 1 min into smaller droplets using an ultrasonic generator, suspending the droplets in 5 mol/L sulfuric acid solution according to an oil to acid ratio of 5:1 to obtain primary emulsion, and further adding sorbitan monooleate with concentration of 2 wt % to the primary emulsion, and stirring at 400 rpm for 20 minutes using a mechanical stirrer, so as to obtain emulsion liquid membrane, wherein pH of original gallium solution was 1.7, and pH of the concentrated gallium solution was 1.09;
(2) mixing gallium leaching solution with the emulsion liquid membrane at a volume ratio of 5:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that Example 4 achieves extraction efficiency value about 90.0%, and gallium ion enrichment concentration may reach 27 times.

### Example 5

Gallium leaching solution was leaching supernatant by first-stage pressurization for zinc sulfide shown in Table 1, containing 0.024 g/L gallium. The solution was evaporated and concentrated to concentration up to 100 ppm for testing.

Example 5 provides a method of extracting and separating gallium by emulsion liquid membrane, including:
(1) ultrasonically dispersing 6.5 wt % G8315 oil drops dissolved in sulfonated kerosene for 1 min into smaller droplets using an ultrasonic generator, suspending the droplets in 4 mol/L sulfuric acid solution according to an oil to acid ratio of 5:1 to obtain primary emulsion, and further adding sorbitan monooleate with concentration of 2 wt % to the primary emulsion, and stirring at 500 rpm for 15 minutes using a mechanical stirrer, so as to obtain emulsion liquid membrane, wherein pH of original gallium solution was 1.7, and pH of the concentrated gallium solution was 1.09;
(2) mixing gallium leaching solution with the emulsion liquid membrane at a volume ratio of 3.5:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that Example 5 achieves extraction efficiency value about 99.4%, and gallium ion enrichment concentration may reach 21 times.

### Example 6

Gallium leaching solution was leaching supernatant by first-stage pressurization for zinc sulfide shown in Table 1, containing 0.024 g/L gallium. The solution was evaporated and concentrated to concentration up to 100 ppm for testing.

Example 6 provides a method of extracting and separating gallium by emulsion liquid membrane, including:
(1) ultrasonically dispersing 6.5 wt % G8315 oil drops dissolved in sulfonated kerosene for 1 min into smaller droplets using an ultrasonic generator, suspending the droplets in 4 mol/L sulfuric acid solution according to an oil to acid ratio of 5:1 to obtain primary emulsion, and further adding sorbitan monooleate with concentration of 2 wt % to the primary emulsion, and stirring at 500 rpm for 25 minutes using a mechanical stirrer, so as to obtain emulsion liquid membrane, wherein pH of original gallium solution was 1.7, and pH of the concentrated gallium solution was 1.09;
(2) mixing gallium leaching solution with the emulsion liquid membrane at a volume ratio of 6.5:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that Example 6 achieves extraction efficiency value about 98.2%, and gallium ion enrichment concentration may reach 38.2 times.

### Example 7

Gallium leaching solution was leaching supernatant by first-stage pressurization for zinc sulfide shown in Table 1, containing 0.024 g/L gallium. The solution was evaporated and concentrated to concentration up to 100 ppm for testing.

Example 7 provides a method of extracting and separating gallium by emulsion liquid membrane, including:
(1) ultrasonically dispersing 5 wt % G8315 oil drops dissolved in sulfonated kerosene for 1 min into smaller droplets using an ultrasonic generator, suspending the droplets in 3 mol/L sulfuric acid solution according to an oil to acid ratio of 5:1 to obtain primary emulsion, and further adding sorbitan monooleate with concentration of 2 wt % to the primary emulsion, and stirring at 400 rpm for 20 minutes using a mechanical stirrer, so as to obtain emulsion liquid membrane, wherein pH of original gallium solution was 1.7, and pH of the concentrated gallium solution was 1.09;
(2) mixing gallium leaching solution with the emulsion liquid membrane at a volume ratio of 5:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that Example 7 achieves extraction efficiency value about 93.0%, and gallium ion enrichment concentration may reach 27.9 times.

### Example 8

Gallium leaching solution was leaching supernatant by first-stage pressurization for zinc sulfide shown in Table 1, containing 0.024 g/L gallium. The solution was evaporated and concentrated to concentration up to 100 ppm for testing.

Example 8 provides a method of extracting and separating gallium by emulsion liquid membrane, including:
(1) ultrasonically dispersing 8 wt % G8315 oil drops dissolved in sulfonated kerosene for 1 min into smaller droplets using an ultrasonic generator, suspending the droplets in 3 mol/L sulfuric acid solution according to an oil to acid ratio of 5:1 to obtain primary emulsion, and further adding sorbitan monooleate with concentration of 2 wt % to the primary emulsion, and stirring at 400 rpm for 20 minutes using a mechanical stirrer, so as to obtain emulsion liquid membrane, wherein pH of original gallium solution was 1.7, and pH of the concentrated gallium solution was 1.09;
(2) mixing gallium leaching solution with the emulsion liquid membrane at a volume ratio of 5:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that Example 8 achieves extraction efficiency value about 99.6%, and gallium ion enrichment concentration may reach 29.9 times.

### Example 9

Gallium leaching solution was leaching supernatant by first-stage pressurization for zinc sulfide shown in Table 1, containing 0.024 g/L gallium. The solution was evaporated and concentrated to concentration up to 100 ppm for testing.

Example 9 provides a method of extracting and separating gallium by emulsion liquid membrane, including:
(1) ultrasonically dispersing 6.5 wt % G8315 oil drops dissolved in sulfonated kerosene for 1 min into smaller droplets using an ultrasonic generator, suspending the droplets in 2 mol/L sulfuric acid solution according to an oil to acid ratio of 5:1 to obtain primary emulsion, and further adding sorbitan monooleate with concentration of 2 wt % to the primary emulsion, and stirring at 500 rpm for 15 minutes using a mechanical stirrer, so as to obtain emulsion liquid membrane, wherein pH of original gallium solution was 1.7, and pH of the concentrated gallium solution was 1.09;
(2) mixing gallium leaching solution with the emulsion liquid membrane at a volume ratio of 6.5:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that Example 9 achieves extraction efficiency value about 92.5%, and gallium ion enrichment concentration may reach 36 times.

### Example 10

Gallium leaching solution was leaching supernatant by first-stage pressurization for zinc sulfide shown in Table 1, containing 0.024 g/L gallium. The solution was evaporated and concentrated to concentration up to 100 ppm for testing.

Example 10 provides a method of extracting and separating gallium by emulsion liquid membrane, including:
(1) ultrasonically dispersing 6.5 wt % G8315 oil drops dissolved in sulfonated kerosene for 1 min into smaller droplets using an ultrasonic generator, suspending the droplets in 2 mol/L sulfuric acid solution according to an oil to acid ratio of 5:1 to obtain primary emulsion, and further adding sorbitan monooleate with concentration of 2 wt % to the primary emulsion, and stirring at 500 rpm for 25 minutes using a mechanical stirrer, so as to obtain emulsion liquid membrane, wherein pH of original gallium solution was 1.7, and pH of the concentrated gallium solution was 1.09;
(2) mixing gallium leaching solution with the emulsion liquid membrane at a volume ratio of 3.5:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that Example 10 achieves extraction efficiency value about 99.0%, and gallium ion enrichment concentration may reach 36 times.

### Example 11

Gallium leaching solution was leaching supernatant by first-stage pressurization for zinc sulfide shown in Table 1, containing 0.024 g/L gallium. The solution was evaporated and concentrated to concentration up to 100 ppm for testing.

Example 11 provides a method of extracting and separating gallium by emulsion liquid membrane, including:
(1) ultrasonically dispersing 3.5 wt % G8315 oil drops dissolved in sulfonated kerosene for 1 min into smaller droplets using an ultrasonic generator, suspending the droplets in 4 mol/L sulfuric acid solution according to an oil to acid ratio of 5:1 to obtain primary emulsion, and further adding sorbitan monooleate with concentration of 2 wt % to the primary emulsion, and stirring at 500 rpm for 25 minutes using a mechanical stirrer, so as to obtain emulsion liquid membrane, wherein pH of original gallium solution was 1.7, and pH of the concentrated gallium solution was 1.09;
(2) mixing gallium leaching solution with the emulsion liquid membrane at a volume ratio of 3.5:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that Example 11 achieves extraction efficiency value about 93.8%, and gallium ion enrichment concentration may reach 19.7 times.

### Example 12

Gallium leaching solution was leaching supernatant by first-stage pressurization for zinc sulfide shown in Table 1, containing 0.024 g/L gallium. The solution was evaporated and concentrated to concentration up to 100 ppm for testing.

Example 12 provides a method of extracting and separating gallium by emulsion liquid membrane, including:
(1) ultrasonically dispersing 5.0 wt % G8315 oil drops dissolved in sulfonated kerosene for 1 min into smaller droplets using an ultrasonic generator, suspending the droplets in 3 mol/L sulfuric acid solution according to an oil to acid ratio of 5:1 to obtain primary emulsion, and further adding sorbitan monooleate with concentration of 2 wt % to the primary emulsion, and stirring at 400 rpm for 25 minutes using a mechanical stirrer, so as to obtain emulsion liquid membrane, wherein pH of original gallium solution was 1.7, and pH of the concentrated gallium solution was 1.09;
(2) mixing gallium leaching solution with the emulsion liquid membrane at a volume ratio of 5:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that Example 12 achieves extraction efficiency value about 96.5%, and gallium ion enrichment concentration may reach 29 times.

### Comparative Example 1

Gallium leaching solution was leaching supernatant by first-stage pressurization for zinc sulfide shown in Table 1, containing 0.024 g/L gallium. The solution was evaporated and concentrated to concentration up to 100 ppm for testing.

Comparative Example 1 provides a method of extracting and separating gallium by emulsion liquid membrane, including:
(1) ultrasonically dispersing 5.0 wt % G8315 oil drops dissolved in sulfonated kerosene for 1 min into smaller droplets using an ultrasonic generator, suspending the droplets in 3 mol/L sulfuric acid solution according to an oil to acid ratio of 5:1 to obtain primary emulsion, and further adding sorbitan monooleate with concentration of 2 wt % to the primary emulsion, and stirring at 400 rpm for 20 minutes using a mechanical stirrer, so as to obtain emulsion liquid membrane, wherein pH of original gallium solution was 1.7, and pH of the concentrated gallium solution was 1.09;
(2) mixing gallium leaching solution with the emulsion liquid membrane at a volume ratio of 2:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that extraction efficiency value of Comparative Example 1 was only 81.5%, and gallium ion enrichment concentration was only 9.8 times. It indicates that when the volume ratio of the gallium leaching solution to the emulsion liquid membrane is too low, it does not facilitate the extraction of gallium ions in the scheme of the present disclosure.

### Comparative Example 2

Gallium leaching solution was leaching supernatant by first-stage pressurization for zinc sulfide shown in Table 1, containing 0.024 g/L gallium. The solution was evaporated and concentrated to concentration up to 100 ppm for testing.

Comparative Example 2 provides a method of extracting and separating gallium by emulsion liquid membrane, including:
(1) ultrasonically dispersing 5.0 wt % G8315 oil drops dissolved in sulfonated kerosene for 1 min into smaller droplets using an ultrasonic generator, suspending the droplets in 3 mol/L sulfuric acid solution according to an oil to acid ratio of 5:1 to obtain primary emulsion, and further adding sorbitan monooleate with concentration of 2 wt % to the primary emulsion, and stirring at 600 rpm for 20 minutes using a mechanical stirrer, so as to obtain emulsion liquid membrane, wherein pH of original gallium solution was 1.7, and pH of the concentrated gallium solution was 1.09;
(2) mixing gallium leaching solution with the emulsion liquid membrane at a volume ratio of 5:1, and contacting Ga³⁺ with the emulsion liquid membrane in Ga₂(SO₄)₃ leaching solution by solvent extraction, so as to form gallium extractant complexes; and
(3) standing after extraction reaction, in which case oil phase was separated from water phase, performing subsequent treatment on the water phase, and demulsifying the oil phase in a high-voltage manner so as to release the concentrated gallium ion water phase solution, in which case the oil phase may be reused. Verification of test result shows that extraction efficiency value of Comparative Example 2 is only 86.2%, and gallium ion enrichment concentration may reach 25.9 times. It indicates that the mechanical stirring speed is too fast to facilitate the extraction of the gallium ions in the scheme of the present disclosure.

Experimental parameters and extraction results of the methods of extracting and separating gallium by emulsion liquid membrane of Example 1 to Example 12 and Comparative Examples 1 and 2 are as shown in Table 2.

TABLE 2
Experimental Parameters and Extraction Results of Various Examples

| | | | | | Volume Ratio | | | |
|---|---|---|---|---|---|---|---|---|
| | | | | | of Gallium | | | |
| | | | | | Leaching | | | |
| | | | | Mechanical | Solution to | | | |
| | Sulfuric Acid | | Mechanical | Stirring | Emulsion | | Gallium Ion | |
| | Concentration | G8315 | Stirring | Duration | Liquid | Extraction | Enrichment | |
| | (mol/L) | Concentration | Speed (rpm) | (minute) | Membrane | Efficiency | Concentration | |
| Example 1 | 5 | 8.0 wt % | 480 | 30 | 3.2 | 99.7% | 19.2 | times |
| Example 2 | 3 | 5.0 wt % | 400 | 20 | 5 | 90.3% | 27 | times |
| Example 3 | 4 | 6.5 wt % | 300 | 25 | 3.5 | 96.6% | 20.3 | times |
| Example 4 | 5 | 5.0 wt % | 400 | 20 | 5 | 90.0% | 27 | times |
| Example 5 | 4 | 6.5 wt % | 500 | 15 | 3.5 | 99.4% | 21 | times |
| Example 6 | 4 | 6.5 wt % | 500 | 25 | 6.5 | 98.2% | 38.2 | times |
| Example 7 | 3 | 5.0 wt % | 400 | 20 | 5 | 93.0% | 27.9 | times |
| Example 8 | 3 | 8.0 wt % | 400 | 20 | 5 | 99.6% | 29.9 | times |
| Example 9 | 2 | 6.5 wt % | 500 | 15 | 6.5 | 92.5% | 36 | times |
| Example 10 | 2 | 6.5 wt % | 500 | 25 | 3.5 | 99.0% | 21 | times |
| Example 11 | 4 | 3.5 wt % | 500 | 25 | 3.5 | 93.8% | 19.7 | times |
| Example 12 | 3 | 5.0 wt % | 400 | 25 | 5 | 96.5% | 29 | times |
| Comparative | 3 | 5.0 wt % | 400 | 20 | 2 | 81.5% | 9.8 | times |
| Example 1 | | | | | | | | |
| Comparative | 3 | 5.0 wt % | 600 | 20 | 5 | 86.2% | 25.9 | times |
| Example 2 | | | | | | | | |

Finally, it should be indicated that various examples above are merely used for illustrating the technical solutions of the present disclosure, rather than limiting the present disclosure. While the detailed description is made to the present disclosure with reference to various preceding examples, those ordinarily skilled in the art should understand that they still could modify the technical solutions recited in various preceding examples, or make equivalent substitutions to some or all of the technical features therein; and these modifications or substitutions do not make the essence of corresponding technical solutions depart from the scope of the technical solutions of various examples of the present disclosure.

Furthermore, those skilled in the art could understand that although some of the examples herein include certain features, but not others, included in other examples, combinations of features of different examples are intended to be within the scope of the present disclosure and form different examples. For example, in the claims, any of the claimed examples may be used in any combination. The information disclosed in the Background Art section is only for enhancement of understanding of the general background art of the present disclosure and should not be regarded as acknowledgment or any form of suggestion that this information forms the prior art already known to those skilled in the art.

What is claimed is:

1. A method of extracting and separating gallium by an emulsion liquid membrane, comprising:
preparation of the emulsion liquid membrane, comprising dispersing an extraction reagent into small droplets, suspending the droplets in a liquid matrix to obtain a primary emulsion, and to the primary emulsion adding a surfactant and stirring a resultant, so as to obtain the emulsion liquid membrane;
extraction, comprising mixing a gallium leaching solution with the emulsion liquid membrane, so as to obtain gallium extractant complexes; and
deextraction, comprising separating the gallium extractant complexes to obtain an oil phase and a water phase, and demulsifying the oil phase and releasing a concentrated gallium ion water phase solution.

2. The method of extracting and separating gallium by an emulsion liquid membrane according to claim 1, wherein the extraction reagent comprises 0,0-dihydroxyphosphorus hydroxamic acid with a molecular formula of (RO)₂P(O)NHOH and a diluent, where R is hydrocarbyl with a carbon chain length of 4˜20 carbons, and the hydrocarbyl is a saturated alkyl, or alkylene containing an unsaturated bond or aryl containing a benzene ring; and
the diluent comprises any one of sulfonated kerosene, gasoline and diesel oil.

3. The method of extracting and separating gallium by an emulsion liquid membrane according to claim 2, wherein mass percentage of the 0,0-dihydroxyphosphorus hydroxamic acid is 20%.

4. The method of extracting and separating gallium by an emulsion liquid membrane according to claim 3, wherein mass percentage concentration of the 0,0-dihydroxyphosphorus hydroxamic acid in the diluent is 3.5-8%.

5. The method of extracting and separating gallium by an emulsion liquid membrane according to claim 1, wherein a volume ratio of the gallium leaching solution to the emulsion liquid membrane is (3-7):1.

6. The method of extracting and separating gallium by an emulsion liquid membrane according to claim 1, wherein the liquid matrix is H₂SO₄, and concentration of the H₂SO₄ is 2.0-5.0 mol/L.

7. The method of extracting and separating gallium by an emulsion liquid membrane according to claim 1, wherein the surfactant is any one or two selected from sorbitan monooleate and sorbitan monostearate.

8. The method of extracting and separating gallium by an emulsion liquid membrane according to claim 1, wherein the extraction reagent is dispersed into the small droplets using an ultrasonic generator; and after the surfactant is added to the primary emulsion, a mechanical stirrer is used to stir to obtain the emulsion liquid membrane.

9. The method of extracting and separating gallium by an emulsion liquid membrane according to claim 8, wherein a stirring duration of the mechanical stirrer is 10-30 minutes; and a stirring speed is 300-500 rpm.

10. The method of extracting and separating gallium by an emulsion liquid membrane according to claim 8, wherein an ultrasonic duration is 0.5˜5 min.
